(19) United States
(12) Patent Application Publication
(10) Pub. No.: US 2026/0115817 A1
(43) Pub. Date: Apr. 30, 2026

(54) GEAR GRINDER AND GEAR GRINDING METHOD

(71) Applicant: NIDEC MACHINE TOOL CORPORATION, Ritto (JP)

(72) Inventors: Michinaga TAWARA, Ritto (JP); Takumi KANEKO, Ritto (JP); Adrianos GEORGOUSSIS, Ritto (JP)

(21) Appl. No.: 19/372,504

(22) Filed: Oct. 29, 2025

(30) Foreign Application Priority Data
Oct. 29, 2024 (JP) 2024-189915

(51) Int. Cl. B23F 1/02

(52) U.S. Cl. CPC B23F 1/023

(57) ABSTRACT

A gear grinder includes a workpiece rotation portion, a grindstone rotation portion, and a movement portion. The workpiece rotation portion rotates a workpiece including a plurality of teeth on an outer peripheral surface about a workpiece axis which is a central axis thereof. The grindstone rotation portion rotates a grindstone including a spiral groove on an outer peripheral surface about a grindstone axis which is a central axis thereof. The movement portion moves the grindstone with respect to the workpiece. The grindstone axis is inclined with respect to the workpiece axis. In the gear grinder, the workpiece rotation portion and the grindstone rotation portion synchronously rotate the workpiece and the grindstone, and the movement portion moves the grindstone along a plane perpendicular or substantially perpendicular to the workpiece axis to grind the workpiece.

### CROSS-REFERENCE TO RELATED APPLICATIONS

The present application claims priority under 35 U.S.C. § 119 to Japanese Patent Application No. 2024-189915, filed on Oct. 29, 2024, the entire contents of which are hereby incorporated herein by reference.

### 1. Field of the Invention

The present invention relates to gear grinders and gear grinding methods.

### 2. Background

Conventionally, a gear grinder that grinds a workpiece serving as a gear is known. A gear grinder synchronously rotates a workpiece including teeth and a grindstone having a spiral groove, and brings the workpiece and the grindstone into contact with each other such that the groove of the grindstone meshes with the teeth of the workpiece. As a result, the grindstone grinds the teeth of the workpiece.

A conventional gear grinder is known.

In a conventional gear grinder, a grindstone is moved in the tooth width direction with respect to a workpiece in order to grind the teeth of the workpiece from one end to the other end in the tooth width direction. That is, in the conventional gear grinder, the grindstone is moved in a direction parallel to the central axis of the workpiece with respect to the workpiece.

However, in the conventional grinding method, the movement range of the grindstone in the tooth width direction is large. For this reason, for example, when grinding a small diameter portion of a workpiece for a multistage gear including a small diameter portion and a large diameter portion, there is a problem that a grindstone moving in the tooth width direction interferes with the large diameter portion. In addition, in a case where the workpiece has a portion having a diameter larger than that of the tooth to be ground other than the multistage gear, the same problem occurs.

### SUMMARY

According to the present disclosure, an example embodiment of a gear grinder to grind a workpiece serving as a gear includes a workpiece rotation portion to rotate a workpiece including teeth on an outer peripheral surface about a workpiece axis that is a central axis of the workpiece, a grindstone rotation portion to rotate a grindstone including a spiral groove on an outer peripheral surface about a grindstone axis which is a central axis of the grindstone, and a movement portion to move the grindstone with respect to the workpiece. The grindstone axis is inclined with respect to the workpiece axis. The workpiece rotation portion and the grindstone rotation portion rotate the workpiece and the grindstone synchronously, and the movement portion grinds the workpiece by moving the grindstone along a plane perpendicular or substantially perpendicular to the workpiece axis.

According to the present disclosure, an example embodiment of a gear grinding method to grind a workpiece serving as a gear includes grinding a workpiece by moving a grindstone with respect to the workpiece while rotating the workpiece including a plurality of teeth on an outer peripheral surface about a workpiece axis which is a central axis of the workpiece and rotating the grindstone including a spiral groove on an outer peripheral surface about a grindstone axis which is a central axis of the grindstone. The grindstone axis is inclined with respect to the workpiece axis. In the step, the workpiece and the grindstone are synchronously rotated, and the grindstone is moved along a plane perpendicular substantially perpendicular to the workpiece axis to grind the workpiece.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a configuration of a gear grinder according to an example embodiment of the present disclosure.

FIG. 2 is a flowchart illustrating a flow of an operation of a gear grinder according to an example embodiment of the present disclosure.

FIG. 3 is a diagram illustrating states of a workpiece and a grindstone in step S4.

FIG. 4 is a diagram illustrating states of a workpiece and a grindstone in step S4.

FIG. 5 is a diagram illustrating states of a workpiece and a grindstone in step S4.

FIG. 6 is a diagram illustrating a state of movement of a contact portion according to an example embodiment of the present disclosure.

FIG. 7 is a diagram illustrating how a workpiece including a first region and a second region is ground according to an example embodiment of the present disclosure.

FIG. 8 is a side view of a grindstone according to a modification of an example embodiment of the present disclosure.

### DETAILED DESCRIPTION

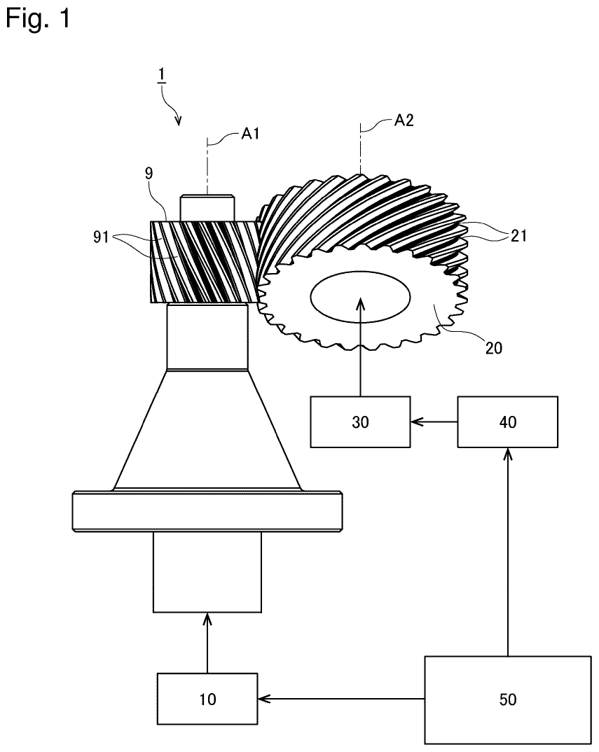

FIG. 1 is a diagram illustrating a configuration of a gear grinder 1 according to an example embodiment of the present invention. The gear grinder 1 is a machine tool that grinds a workpiece 9 serving as a gear.

The workpiece 9 has a substantially cylindrical shape, and has a plurality of teeth 91 on an outer peripheral surface thereof. Hereinafter, the central axis of the workpiece 9 is referred to as a “workpiece axis A1”. The gear manufactured by grinding the workpiece 9 is, for example, a helical gear. The workpiece 9 serving as a helical gear has the spiral teeth 91 centered on the workpiece axis A1. However, the gear manufactured by grinding the workpiece 9 may be another gear such as a spur gear.

As illustrated in FIG. 1, the gear grinder 1 includes a workpiece rotation portion 10, a grindstone 20, a grindstone rotation portion 30, a movement portion 40, and a control unit 50. The workpiece rotation portion 10, the grindstone rotation portion 30, and the movement portion 40 are installed on a common bed (not illustrated).

The workpiece rotation portion 10 is a mechanism that rotates the workpiece 9 about the workpiece axis A1. The workpiece rotation portion 10 includes a pair of clampers that hold the workpiece 9 and a motor that rotates the clampers. In the present example embodiment, the workpiece 9 rotates while being held in a posture in which the workpiece axis A1 faces the vertical direction. However, the direction of the workpiece axis A1 is not necessarily the vertical direction.

The grindstone 20 is a tool for grinding the teeth 91 of the workpiece 9. The grindstone 20 has a substantially cylindrical shape, and has a spiral groove 21 on an outer peripheral surface thereof. Hereinafter, the central axis of the grindstone 20 is referred to as a “grindstone axis A2”.

The grindstone rotation portion 30 is a mechanism that rotates the grindstone 20 about the grindstone axis A2. The grindstone rotation portion 30 includes a tool head that holds the grindstone 20 and a motor that rotates the tool head. The grindstone 20 is held in a posture in which the grindstone axis A2 is inclined with respect to the workpiece axis A1. That is, in the present example embodiment, the grindstone 20 is held in a posture in which the grindstone axis A2 is inclined with respect to the horizontal direction and the vertical direction.

The movement portion 40 is a mechanism that moves the grindstone 20 with respect to the workpiece 9. The movement portion 40 moves the entire grindstone 20 and the grindstone rotation portion 30. The movement portion 40 includes a first mechanism for moving the grindstone 20 closer to and away from the workpiece 9, a second mechanism for moving the grindstone 20 in the vertical direction, and a third mechanism for moving the grindstone 20 in a direction along the grindstone axis A2 (hereinafter, referred to as “grindstone axial direction”). Each mechanism is realized by, for example, a motor and a ball screw that converts rotation of the motor into linear motion. With the first mechanism, the second mechanism, and the third mechanism, the movement portion 40 can move the grindstone 20 in an arbitrary direction in the three-dimensional space with respect to the workpiece 9.

The movement portion 40 may include a fourth mechanism that adjusts the inclination angle of the grindstone axis A2 with respect to the workpiece axis A1.

The control unit 50 is a unit that controls the operation of each unit of the gear grinder 1. The control unit 50 is constituted by, for example, a computer having a processor such as a CPU, a memory such a RAM, and a storage unit such as a hard disk. The storage unit stores a computer program for controlling the operation of the gear grinder 1.

In addition, the control unit 50 is communicably connected to the workpiece rotation portion 10, the grindstone rotation portion 30, and the movement portion 40 described above. The control unit 50 controls the operation of these units in accordance with the computer program described above. As a result, the grinding processing of the workpiece 9 in the gear grinder 1 proceeds.

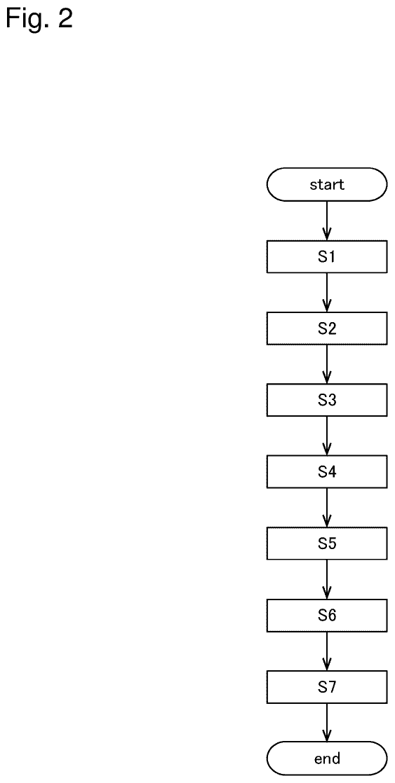

Next, a method of grinding the workpiece 9 to be a gear by the gear grinder 1 will be described. FIG. 2 is a flowchart illustrating a flow of an operation of the gear grinder 1.

When grounding the workpiece 9, first, the workpiece 9 is set in the gear grinder 1 (step S1). The workpiece 9 is held by a pair of clampers of the workpiece rotation portion 10. Thereafter, the workpiece rotation portion 10 starts rotation of the workpiece 9 about the workpiece axis A1 (step S2). In addition, the grindstone rotation portion 30 starts rotation of the grindstone 20 about the grindstone axis A2 (step S3).

The control unit 50 controls the workpiece rotation portion 10 and the grindstone rotation portion 30 so that the workpiece 9 and the grindstone 20 rotate synchronously. The synchronous rotation means that the workpiece 9 and the grindstone 20 rotate in a phase capable of meshing with each other. The control unit 50 moves the grindstone 20 with respect to the workpiece 9 by the movement portion 40 in a state where the workpiece 9 and the grindstone 20 are synchronously rotated by the workpiece rotation portion 10 and the grindstone rotation portion 30 (step S4).

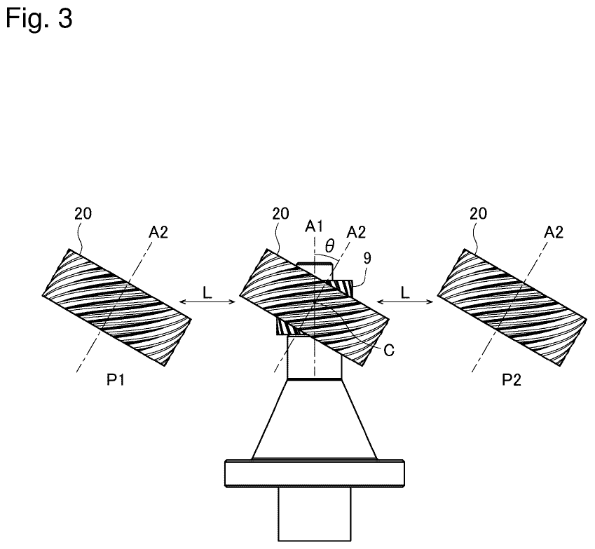

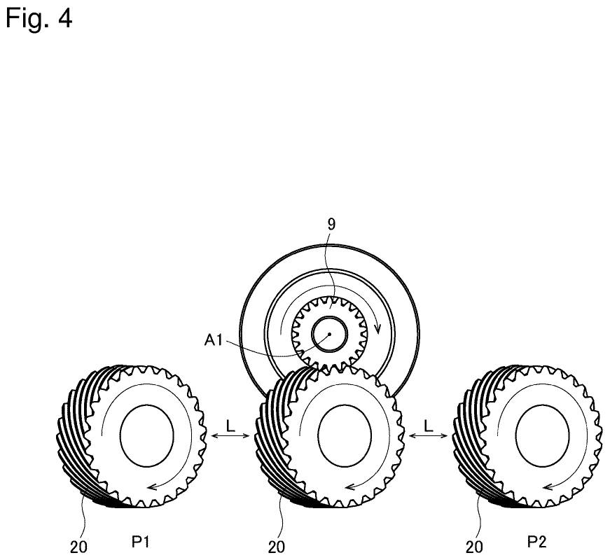

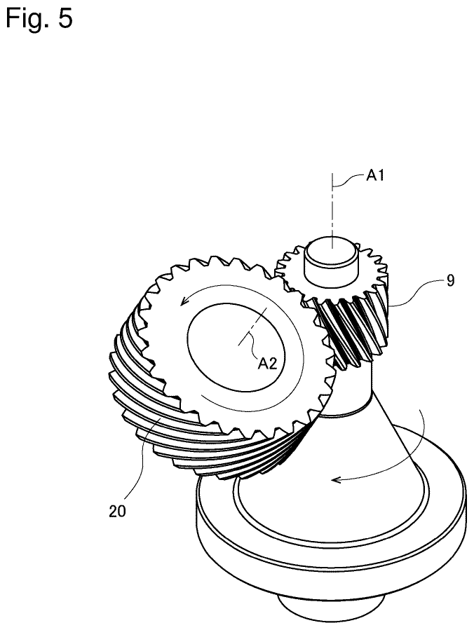

FIGS. 3, 4, and 5 are diagrams illustrating states of the workpiece 9 and the grindstone 20 in step S4. As illustrated in FIGS. 3 and 4, the movement portion 40 moves the grindstone 20 along a plane perpendicular or substantially perpendicular to the workpiece axis A1. Specifically, the movement portion 40 moves the grindstone 20 along a linear path L between a first position P1 and a second position P2 illustrated in FIGS. 3 and 4. The grindstone 20 comes into contact with the workpiece 9 on the path L between the first position P1 and the second position P2. At this time, since the workpiece 9 and the grindstone 20 rotate synchronously, the teeth 91 and the groove 21 come into contact with each other in a state of being meshed with each other.

As illustrated in FIG. 3, the grindstone axis A2 is inclined with respect to the workpiece axis A1. Therefore, the grindstone 20 comes into contact with the workpiece 9 only in the vicinity of the portion where the workpiece axis A1 and the grindstone axis A2 intersect in FIG. 3. Hereinafter, a portion where the grindstone 20 and the workpiece 9 are in contact with each other is referred to as a “contact portion C”. In the contact portion C, the teeth 91 of the workpiece 9 and the groove 21 of the grindstone 20 come into sliding contact with each other at a sliding speed corresponding to the intersection angle θ. As a result, the surface of the teeth 91 of the workpiece 9 is ground.

The intersection angle θ of the grindstone axis A2 with respect to the workpiece axis A1 is desirably, for example, 3° or more and 35° or less. As a result, it is possible to generate an appropriate sliding speed in the contact portion C while suppressing the intersection angle θ. The intersection angle θ of the grindstone axis A2 with respect to the workpiece axis A1 is more desirably 5° or more and 12° or less. As a result, a more appropriate sliding speed can be generated in the contact portion C.

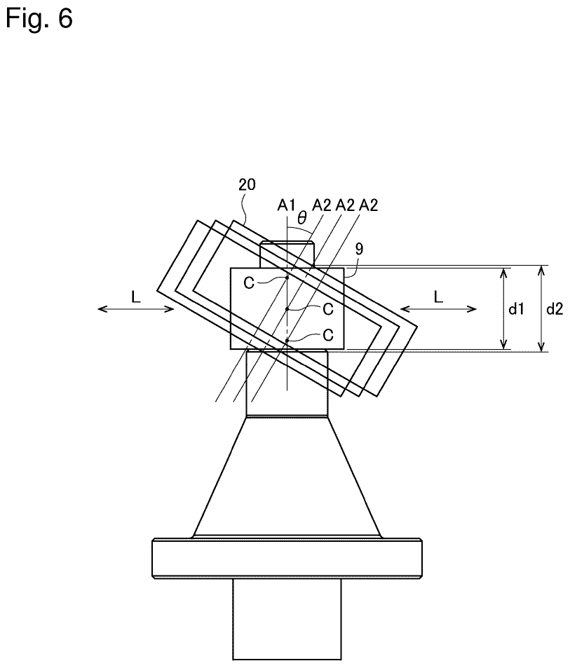

FIG. 6 is a diagram illustrating how the contact portion C moves. As illustrated in FIG. 6, a length d2 of the grindstone 20 in a direction parallel to the workpiece axis A1 (hereinafter, referred to as “workpiece axial direction”) is longer than a length d1 of the teeth 91 of the workpiece 9 in the workpiece axial direction. More specifically, the length d2 of the portion of the grindstone 20 overlapping the grindstone axis A2 in FIG. 6 in the workpiece axial direction is longer than the length d1 of the teeth 91 of the workpiece 9 in the workpiece axial direction. In step S4, as the grindstone 20 moves along the path L, the position of the contact portion C moves in the workpiece axial direction as illustrated in FIG. 6. As a result, the teeth 91 of the workpiece 9 are ground from one end to the other end in the workpiece axial direction.

After moving the grindstone 20 from the first position P1 to the second position P2, the gear grinder 1 moves the grindstone 20 from the second position P2 to the first position P1 without changing the direction of rotation of the workpiece 9 and the direction of rotation of the grindstone 20. As a result, the surface of the teeth 91 of the workpiece 9 can be ground a plurality of times. In the present example embodiment, the grindstone 20 reciprocates between the first position P1 and the second position P2 without changing the direction of rotation of the workpiece 9 and the direction of rotation of the grindstone 20. That is, the grindstone 20 repeats the movement from the first position P1 to the second position P2 and the movement from the second position P2 to the first position P1. As a result, the grindstone 20 repeatedly comes into contact with the workpiece 9. As a result, the surface of the teeth 91 of the workpiece 9 can be sufficiently ground by the grindstone 20.

After reciprocating movement of the grindstone 20 a predetermined number of times, the movement portion 40 stops the grindstone 20 at the first position P1 or the second position P2. Then, the grindstone rotation portion 30 stops the rotation of the grindstone 20 (step S5), and the workpiece rotation portion 10 stops the rotation of the workpiece 9 (step S6). Thereafter, the workpiece 9 is taken out from the gear grinder 1 (step S7). When the workpiece 9 is automatically replaced by the loader and the next workpiece 9 is continuously ground, the above-described step S5 may be omitted and the rotation of the grindstone 20 may be continued.

As described above, in the gear grinder 1 of the present example embodiment, the movement portion 40 grinds the workpiece 9 by moving the grindstone 20 along a plane perpendicular or substantially perpendicular to the workpiece axis A1 instead of moving the grindstone 20 in the workpiece axial direction as in the related art. As a result, the workpiece 9 can be ground while limiting the movement range of the grindstone 20 in the workpiece axial direction.

In particular, in the gear grinder 1 of the present example embodiment, the movement portion 40 moves the grindstone 20 along a straight line in contact with the workpiece 9 on a plane perpendicular or substantially perpendicular to the workpiece axis A1. When the workpiece 9 is moved linearly in this manner, the movement direction of the grindstone 20 can be more easily controlled than when the workpiece 9 is moved in a curved shape.

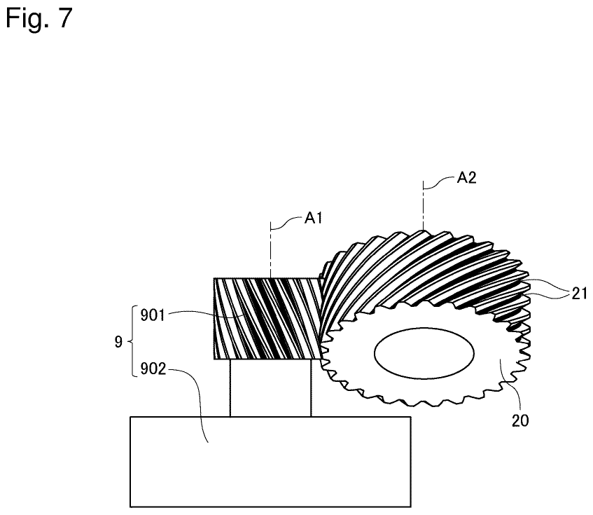

The gear grinder 1 of the present example embodiment is particularly useful when grinding the workpiece 9 as illustrated in FIG. 7. The workpiece 9 of FIG. 7 has a first region 901 and a second region 902. The first region 901 protrudes in the radial direction with respect to the workpiece axis A1. The second region 902 protrudes in the radial direction with respect to the workpiece axis A1, and has a diameter larger than that of the first region 901. In the example of FIG. 7, the grindstone 20 grinds the first region 901 of the workpiece 9. In this case, when the grindstone 20 is moved in the workpiece axial direction as in the conventional case, the grindstone 20 comes into contact with the second region 902 of the workpiece 9. However, in the method of the present example embodiment, the grindstone 20 is moved along a plane perpendicular or substantially perpendicular to the workpiece axis A1. As a result, the first region 901 can be ground without bringing the grindstone 20 into contact with the second region 902.

The workpiece 9 in FIG. 7 is, for example, a two-stage gear. In this case, the first region 901 of the workpiece 9 becomes the small-diameter gear of the two-stage gear, and the second region 902 of the workpiece 9 becomes the large-diameter gear of the two-stage gear. In recent years, with the spread of electric vehicles and the like, it is required to manufacture a two-stage gear with an integrated member. In addition, in order to downsize a gear box of an electric vehicle, it is required to reduce an axial length of a two-stage gear. In this case, since the interval between the first region 901 and the second region 902 of the workpiece 9 in the workpiece axial direction becomes small, it is difficult to grind the first region 901 by the conventional method. However, as described above, according to the method of the present example embodiment, the first region 901 can be ground without bringing the grindstone 20 into contact with the second region 902. This contributes to downsizing of the gear box.

In grinding processing, it is necessary to increase the peripheral speed of the grindstone in order to perform processing satisfactorily as compared with cutting processing such as shaving. In the conventional gear grinder, the peripheral speed of the grindstone is secured by increasing the diameter of the grindstone. However, when the diameter of the grindstone is increased by the conventional method, the grindstone 20 comes into contact with the second region 902 of the workpiece 9 as described above. However, in the method of the present example embodiment, the intersection angle θ between the workpiece axis A1 and the grindstone axis A2 is made smaller than that in the related art, and the workpiece 9 is moved along a plane perpendicular or substantially perpendicular to the workpiece axis A1. Therefore, the first region 901 can be ground without bringing the grindstone 20 into contact with the second region 902 while increasing the diameter of the grindstone 20 to some extent.

While the example embodiments of the present disclosure have been described above, the present disclosure is not limited to the example embodiments described above.

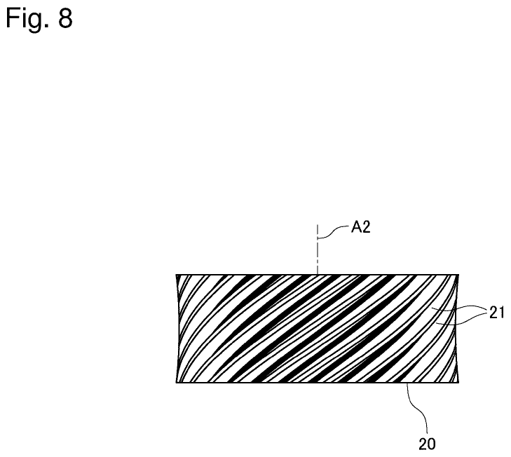

FIG. 8 is a side view of a grindstone 20 according to a modification. In the above example embodiment, the rough shape surface of the outer peripheral surface of the grindstone 20 ignoring the groove 21 has a straight cylindrical shape. That is, in the above example embodiment, the outer diameter at both end portions of the grindstone 20 in the grindstone axial direction is the same as the outer diameter at the central portion of the grindstone 20 in the grindstone axial direction. On the other hand, in the example of FIG. 8, a rough shape surface of the outer peripheral surface of the grindstone 20 ignoring the groove 21 is curved in a drum shape. That is, in the example of FIG. 8, the outer diameter at both end portions of the grindstone 20 in the grindstone axial direction is larger than the outer diameter at the central portion of the grindstone 20 in the grindstone axial direction. By using such a grindstone 20, the grinding amount of both end portions of the workpiece 9 in the workpiece axial direction can be further increased.

In the above example embodiment, the movement portion 40 moves the grindstone 20 along the linear path L. However, the movement portion 40 may move the grindstone 20 along a curved path. For example, the movement portion 40 may move the grindstone 20 along an arc inscribed with the workpiece 9 on a plane perpendicular or substantially perpendicular to the workpiece axis A1.

Also note that features of the above-described example embodiments and the modifications thereof may be combined appropriately as long as no conflict arises.

The present technology can have the following configurations.
(1) A gear grinder to grind a workpiece serving as a gear, the gear grinder including: a workpiece rotation portion to rotate a workpiece including a plurality of teeth on an outer peripheral surface about a workpiece axis that is a central axis of the workpiece; a grindstone rotation portion to rotate a grindstone including a spiral groove on an outer peripheral surface about a grindstone axis which is a central axis of the grindstone; and a movement portion to move the grindstone with respect to the workpiece, in which the grindstone axis is inclined with respect to the workpiece axis, and the workpiece rotation portion and the grindstone rotation portion rotate the workpiece and the grindstone synchronously, and the movement portion grinds the workpiece by moving the grindstone along a plane perpendicular or substantially perpendicular to the workpiece axis.
(2) The gear grinder according to (1), in which the movement portion moves the grindstone along a straight line in contact with the workpiece on the plane.
(3) The gear grinder according to (1) or (2), in which a length of the grindstone in the workpiece axial direction is longer than a length of the teeth of the workpiece in the workpiece axial direction.
(4) The gear grinder according to any one of (1) to (3), in which an intersection angle of the grindstone axis with respect to the workpiece axis is about 3° or more and about 35° or less.
(5) The gear grinder according to any one of (1) to (4), in which the movement portion repeatedly brings the grindstone into contact with the workpiece due to reciprocating movement of the grindstone with respect to the workpiece without changing a rotation direction of the workpiece and a rotation direction of the grindstone.
(6) The gear grinder according to any one of (1) to (5), in which an outer diameter at two end portions of the grindstone in the grindstone axial direction is larger than an outer diameter at a central portion of the grindstone in the grindstone axial direction.
(7) The gear grinder according to any one of (1) to (6), in which the workpiece includes: a first region that protrudes in a radial direction with respect to the workpiece axis; and a second region that protrudes in a radial direction with respect to the workpiece axis and has a diameter larger than a diameter of the first region, and the grindstone grinds the first region.
(8) A gear grinding method for grinding a workpiece serving as a gear, the method including: grinding a workpiece by moving a grindstone with respect to the workpiece while rotating the workpiece including a plurality of teeth on an outer peripheral surface about a workpiece axis which is a central axis of the workpiece and rotating the grindstone including a spiral groove on an outer peripheral surface about a grindstone axis which is a central axis of the grindstone, in which the grindstone axis is inclined with respect to the workpiece axis, and in the step, the workpiece and the grindstone are synchronously rotated, and the grindstone is moved along a plane perpendicular or substantially perpendicular to the workpiece axis to grind the workpiece.
(9) The gear grinding method according to (8), in which, in the grinding, the grindstone is moved along a straight line in contact with the workpiece on the plane.
(10) The gear grinding method according to (8) or (9), in which a length of the grindstone in a workpiece axial direction is longer than a length of the teeth of the workpiece in the workpiece axial direction.
(11) The gear grinding method according to any one of (8) to (10), in which an intersection angle of the grindstone axis with respect to the workpiece axis is about 3° or more and about 35° or less.
(12) The gear grinding method according to any one of (8) to (11), in which, in the step, the grindstone is repeatedly brought into contact with the workpiece by reciprocating movement of the grindstone with respect to the workpiece without changing a rotation direction of the workpiece and a rotation direction of the grindstone.
(13) The gear grinding method according to any one of (8) to (12), in which an outer diameter at two end portions of the grindstone in the grindstone axial direction is larger than an outer diameter at a central portion of the grindstone in the grindstone axial direction.
(14) The gear grinding method according to any one of (8) to (13), in which the workpiece includes a first region that protrudes in a radial direction with respect to the workpiece axis, and a second region that protrudes in a radial direction with respect to the workpiece axis and has a diameter larger than a diameter of the first region, and the grindstone grinds the first region.

Example embodiments of the present disclosure and modifications thereof can be used for a gear grinder and a gear grinding method.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A gear grinder to grind a workpiece serving as a gear, the gear grinder comprising:
a workpiece rotation portion to rotate a workpiece including a plurality of teeth on an outer peripheral surface about a workpiece axis that is a central axis of the workpiece;
a grindstone rotation portion to rotate a grindstone including a spiral groove on an outer peripheral surface about a grindstone axis which is a central axis of the grindstone; and
a movement portion to move the grindstone with respect to the workpiece; wherein
the grindstone axis is inclined with respect to the workpiece axis; and
the workpiece rotation portion and the grindstone rotation portion rotate the workpiece and the grindstone synchronously, and the movement portion grinds the workpiece by moving the grindstone along a plane perpendicular or substantially perpendicular to the workpiece axis.

2. The gear grinder according to claim 1, wherein the movement portion moves the grindstone along a straight line in contact with the workpiece on the plane.

3. The gear grinder according to claim 1, wherein a length of the grindstone in the workpiece axial direction is longer than a length of the teeth of the workpiece in the workpiece axial direction.

4. The gear grinder according to claim 1, wherein an intersection angle of the grindstone axis with respect to the workpiece axis is about 3° or more and about 35° or less.

5. The gear grinder according to claim 1, wherein the movement portion repeatedly brings the grindstone into contact with the workpiece by performing reciprocating movement of the grindstone with respect to the workpiece without changing a rotation direction of the workpiece and a rotation direction of the grindstone.

6. The gear grinder according to claim 1, wherein an outer diameter at two end portions of the grindstone in the grindstone axial direction is larger than an outer diameter at a central portion of the grindstone in the grindstone axial direction.

7. The gear grinder according to claim 1, wherein
the workpiece includes:
a first region that protrudes in a radial direction with respect to the workpiece axis; and
a second region that protrudes in a radial direction with respect to the workpiece axis and has a diameter larger than a diameter of the first region; and
the grindstone grinds the first region.

8. A gear grinding method for grinding a workpiece serving as a gear, the method comprising:
grinding a workpiece by moving a grindstone with respect to the workpiece while rotating the workpiece including a plurality of teeth on an outer peripheral surface about a workpiece axis which is a central axis of the workpiece and rotating the grindstone including a spiral groove on an outer peripheral surface about a grindstone axis which is a central axis of the grindstone; wherein
the grindstone axis is inclined with respect to the workpiece axis; and
in the grinding, the workpiece and the grindstone are synchronously rotated, and the grindstone is moved along a plane perpendicular or substantially perpendicular to the workpiece axis to grind the workpiece.

9. The gear grinding method according to claim 8, further comprising moving the grindstone along a straight line in contact with the workpiece on the plane.

10. The gear grinding method according to claim 8, wherein a length of the grindstone in a workpiece axial direction is longer than a length of the teeth of the workpiece in the workpiece axial direction.

11. The gear grinding method according to claim 8, wherein an intersection angle of the grindstone axis with respect to the workpiece axis is about 3° or more and about 35° or less.

12. The gear grinding method according to claim 8, wherein, in the step, the grindstone is repeatedly brought into contact with the workpiece by reciprocating movement of the grindstone with respect to the workpiece without changing a rotation direction of the workpiece and a rotation direction of the grindstone.

13. The gear grinding method according to claim 8, wherein an outer diameter at two end portions of the grindstone in the grindstone axial direction is larger than an outer diameter at a central portion of the grindstone in the grindstone axial direction.

14. The gear grinding method according to claim 8, wherein
the workpiece includes:
a first region that protrudes in a radial direction with respect to the workpiece axis; and
a second region that protrudes in a radial direction with respect to the workpiece axis and has a diameter larger than a diameter of the first region; and
the grindstone grinds the first region.
